(19) United States
(12) Patent Application Publication
(10) Pub. No.: US 2002/0053564 A1
(43) Pub. Date: May 9, 2002

(54) Staple for holding heating element in place

(76) Inventors: Christopher Ryan Taylor, Columbus, MS (US); Philip Wayne Hunnicutt, Winfield, AL (US); Byron Neal Cantrell, Beaverton, AL (US)

Correspondence Address: Thomas V. Miller, Howrey Simon Arnold & White, LLP, PO Box 4433, Houston, TX, 77210-4433, US

(21) Appl. No.: 09/853,309

(22) Filed: May 11, 2001

Related U.S. Application Data
(63) Continuation-in-part of application No. 09/710,563, filed on Nov. 9, 2000.

(51) Int. Cl. H05B 3/68

(52) U.S. Cl. 219/461.1; 219/460.1; 219/462.1; 338/284

(57) ABSTRACT

The present invention provides a staple for a heating unit. In one embodiment, the heating unit has a base, a first insulation layer, a second insulation layer, and a heating element. The first insulation layer has a top surface and a bottom surface. The heating element rests on the top surface of the first insulation layer. The staple includes a base and a plurality of legs. The base is capable of straddling a portion of the heating element. At least one of the plurality of legs is capable of extending through the top and bottom surfaces of the first insulation layer. A portion of the leg extending through the bottom surface of the first insulation layer is capable of being rolled to form a foot. The second insulation layer is located between the bottom surface of the first insulation layer and the base. In another embodiment, the present invention includes a staple for a heating unit having an insulation layer and a heating element. The heating element rests on the top surface of the insulation layer. The staple includes a base, a leg and a barb. The base is capable of straddling a portion of the heating element. The leg extends from the base and the barb is attached to the extended leg. The barb and a portion of the extended leg are capable of extending through the top surface of the insulation layer and retaining the heating element on the top surface of the insulation layer during repeated temperature cycles of the heating element.

The present application is a continuation-in-part application and claims priority from Application Ser. No. 09/710,563 entitled “Modular Radiant Heater Units for Use in Grills and the Like” filed Nov. 9, 2000, commonly owned by the assignee of the present invention and incorporated herein by reference in its entirety.

### FIELD OF THE INVENTION

The present invention relates generally to heating units employing heat elements, and more particularly, to a staple used to attach and hold such an element in place on a thermal and electrical insulation material.

### BACKGROUND OF THE INVENTION

In electrical heating units of the type used in grills, one type of heating element employed is an electrical coiled heating element. The coiled heating element is laid out in serpentine or sinuous pattern on an insulating cake base. It has been known to use metal staples to secure the heating element in place. A microwire staple for a ribbon-type heating element is described in U.S. Pat. No. 5,977,524, which is commonly owned by the assignee of the present application and incorporated herein by reference in its entirety.

FIGS. 2A-2C illustrate one type of metal staple 10 currently used to secure a coiled heating element 16. The staple 10 has a base 14 and legs 12. The legs 12 of the staple 10 are pressed into an insulation layer 20. The insulation layer 20 rests on a pan 30. The legs 12 must be shorter than the thickness of the insulation layer 20 to prevent the staple 10 from making contact with the pan 30.

There are, however, problems with this approach. For example, over time, as the coiled heating element is subjected to repeated temperature cycles, the staple may work its way loose. This is a particular problem for staples located at the serpentine turns of the coiled heating element. This is also true for heating units that are required to be in the inverted position.

The present invention is directed to overcoming, or at least reducing the effects of, one or more of the problems set forth above.

### SUMMARY OF THE INVENTION

To that end, the present invention includes a staple for a heating unit. The heating unit has a base, a first insulation layer, a second insulation layer, and a heating element. The first insulation layer has a top surface and a bottom surface. The heating element rests on the top surface of the first insulation layer. The staple includes a base and a plurality of legs. The base is capable of straddling a portion of the heating element. At least one of the plurality of legs is capable of extending through the top and bottom surfaces of the first insulation layer. A portion of the at least one leg extending through the bottom surface of the first insulation layer is capable of being rolled to form a foot. The second insulation layer is located between the bottom surface of the first insulation layer and the base.

The staple may be made of a metallic alloy material. In one embodiment, a microwire staple is used having a diameter of less than 0.012 inch. The staple design of the present invention is preferably used for coiled-type heating elements although it is contemplated that the staple design may be used for other types of heating elements, such as ribbon-type heating elements.

In another embodiment, the present invention includes a heating unit comprising a pan, a first insulation layer, a second insulation layer, a heating element, and a plurality of staples. The pan has a generally flat base and a circumferential sidewall. The first insulation layer has an insulation base and a circumferential sidewall. The second insulation layer is positioned between the insulation base of the first insulation layer and the flat base of the pan. The heating element is supported on the insulation base of the first insulation layer. The plurality of staples are used to retain the heating element on the insulation base of the first insulation layer. The staples extend through the insulation base of the first insulation layer. The heating unit may be used for heating a grill plate, although the present invention may be used in other types of heating units such as heating units for toaster ovens.

In a further embodiment, the present invention includes a staple for a heating unit. The heating unit has an insulation layer and a heating element. The heating element rests on the top surface of the insulation layer. The staple includes a base, a leg and a barb. The base is capable of straddling a portion of the heating element. The leg extends from the base and the barb is attached to the extended leg. The barb and a portion of the extended leg are capable of extending through the top surface of the insulation layer and retaining the heating element on the top surface of the insulation layer during repeated temperature cycles of the heating element.

Another embodiment of the present invention includes a heating unit comprising of a pan, an insulation layer, a heating element, and a plurality of staples. The pan has a generally flat base and a circumferential sidewall. The insulation layer has an insulation base and a circumferential sidewall, and rests at least partially inside the pan. The heating element is supported on the insulation base of the insulation layer. The plurality of staples are used to retain the heating element on the insulation base of the insulation layer. Each staple has a base, at least one leg and at least one barb. The at least one barb is attached to the at least one leg. The at least one barb and a portion of the at least one leg extends into the insulation base of the insulation layer.

The above summary of the present invention is not intended to represent each embodiment, or every aspect of the present invention. This is the purpose of the figures and detailed description that follows.

### BRIEF DESCRIPTION OF THE DRAWINGS

Other objects and advantages of the invention will become apparent upon reading the following detailed description and upon reference to the drawings.

FIG. 1 is a plan view of a heating unit using staples of the present invention;

FIG. 2A is a side view of a prior art staple;

FIGS. 2B and 2C are cross-sectional views of a prior art staple used in a heating unit.

FIG. 3A is a side view of one embodiment of a staple of the present invention;

FIGS. 3B and 3C are cross-sectional views of the staple in FIG. 3A as used in a heating unit.

FIG. 4A is a side view of another embodiment of a staple of the present invention;

FIGS. 4B and 4C are cross-sectional views of the staple in FIG. 4A as used in a heating unit.

While the invention is susceptible to various modifications and alternative forms, certain specific embodiments thereof have been shown by way of example in the drawings and will be described in detail. It should be understood, however, that the intention is not to limit the invention to the particular forms described. On the contrary, the intention is to cover all modifications, equivalents, and alternatives falling within the spirit and scope of the invention as defined by the appended claims.

### DESCRIPTION OF ILLUSTRATIVE EMBODIMENTS

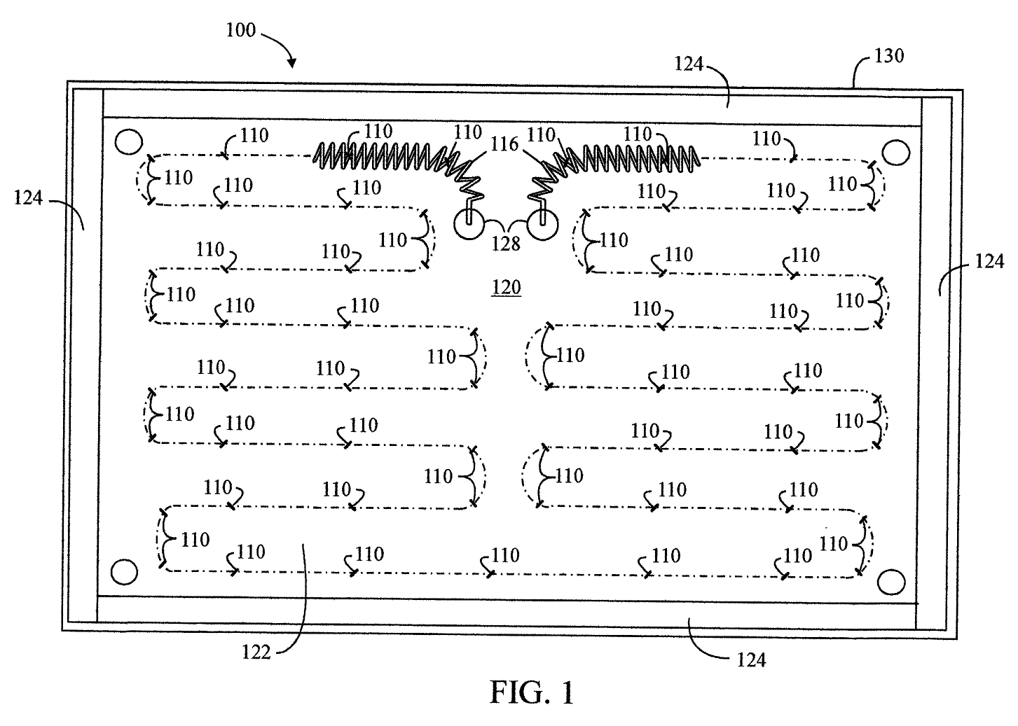

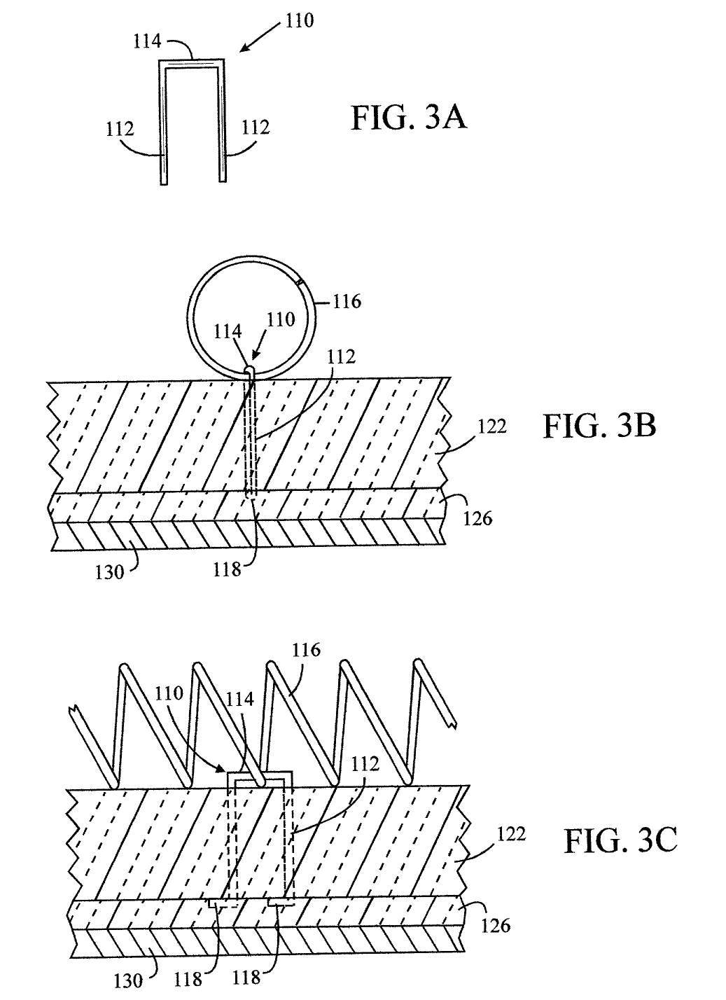

Illustrative embodiments will now be described with reference to the accompanying figures. Turning to the drawings, FIG. 1 depicts a heating unit 100 that may be used in grills or the like. The heating unit 100 is mounted below a grill plate (not shown) to cook food. The heating unit 100 shown in FIG. 1 is for illustrative purposes only and the present invention is not limited to heating units for grills. For example, the present invention may be used in smaller heating units such as those used in toasters where the heating unit may be in the inverted position. In one embodiment, the heating unit 100 has a coiled heating element 116, a first insulation layer 120, a second insulation layer 126 (see FIGS. 3B-3C), a support pan 130, and a plurality of staples 110.

For one embodiment, as shown in FIG. 1, the pan 130 of the heating unit 100 is rectangular in shape. The pan 130 has a generally flat base and a circumferential sidewall. The first insulation layer 120 is sized to fit in the pan 130. In one embodiment, the first insulation layer 120 may comprise of a cake base 122 and circumferential sidewalls 124. Suitable insulation materials for the first insulation layer 120 include Wacker WDS ® Thermal Insulation from Wacker Silicones Corp. in Adrian, Mich. and RPC2100 from Thermal Ceramics in Augusta, Ga. The present invention is not limited to these types of insulation materials and a variety of other insulation materials known in the art may be used. In one embodiment, the cake base 122 is made of Wacker WDS ® and the insulation sidewalls 124 are made of RPC2100.

In the preferred embodiment, the insulation sidewalls 124 extend higher than the sidewalls of the pan 130. This allows the insulation sidewalls 124 to touch the bottom surface of the grill plate and create a seal for a heating cavity C of the heating unit 100. The heating cavity C is defined by the insulation sidewalls 124 in the horizontal direction, and the cake base 124 and the bottom surface of the grill plate in the vertical direction.

The coiled heating element 116 is supported on the cake base 122. As shown in FIG. 1, the coiled heating element 116 is laid out in a serpentine or sinuous pattern on the insulating cake base 122. The pattern shown in FIG. 1 is illustrative only, and the heating element may be laid out in other patterns without departing from the scope of the invention. In one embodiment, as shown in FIG. 1, the contour of the coiled heating element 116 is designed to provide a uniform heat distribution along the cavity C.

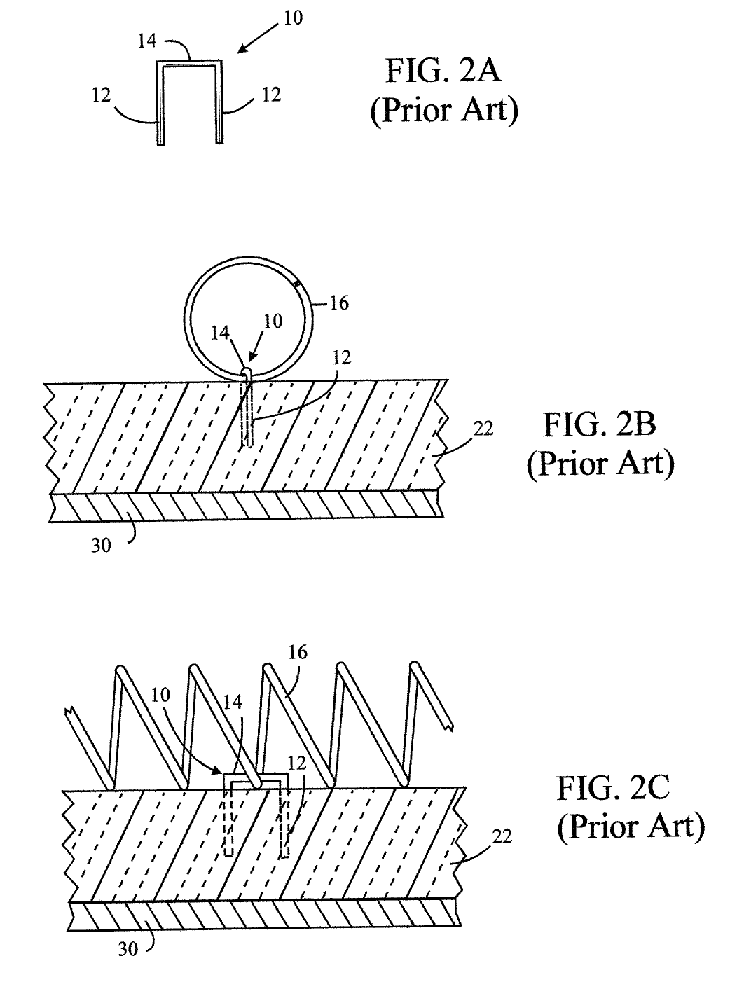

The coiled heating element 116 is held to the insulation cake base 122 by a plurality of staples 110. It has been discovered, however, that conventional staples used for coiled heating elements may come loose over repeated temperature cycles. This is particularly true for staples located at the turns of the serpentine or sinuous pattern. A conventional staple is illustrated in FIGS. 2A-2C. The problems with conventional staples are discussed in the background section.

Accordingly, in one embodiment, the present invention includes staples 110 as illustrated in FIGS. 3A-3C. Each staple 110 has a base 114 and legs 112. Unlike the prior art, the legs 112 of the staple 110 are longer than the thickness of the insulation cake base 122. This allows a portion of the legs 112 to extend through the cake base 122. The portion of the legs 112 that pass through the cake base 122 are then crimped or rolled on the bottom side of the cake base 122 to form feet 118. Crimping or rolling the staple 110 on the bottom side of the cake base 122 prevents the staple 110 from coming loose during temperature cycles of the heating unit 100.

The staples 110, however, should not make contact with the metal pan 130. As shown in FIGS. 3B and 3C, to prevent the staples 110 from touching the metal pan 130, a second insulation layer or blanket 126 is installed between the cake base 122 and the pan 130. One suitable material for the second insulation layer 126 is K-Shield BF Paper from Thermal Ceramics in Augusta, Ga. although other types of insulation materials may be used. What is important is that there is insulation material between the ends of the staples 110 and the metal pan 130. The base 114 of the staple 110 retains one turn of the coiled heating element 116. As shown in FIG. 1, a plurality of staples may be located along the length of the heating element 116 to allow the element to maintain its pattern.

The staple 210 is made of a metallic alloy material. In one embodiment, a microwire staple is used having a diameter of less than0.012″. In any event, it is preferred that the staple 210 is made of a material that is capable of withstanding high temperatures and repeated temperature cycles to which the heating element is subjected.

Referring back to FIG. 1, the ends of the coiled heating element 116 extend through holes 128 and terminate in an electrical connector (not shown) mounted to the bottom of the pan 130. A temperature control system (not shown) is electrically connected to the heating element 116. The temperature control system controls the power to the heating element 116. A variety of temperature control means may be employed as known to those of ordinary skill in the art.

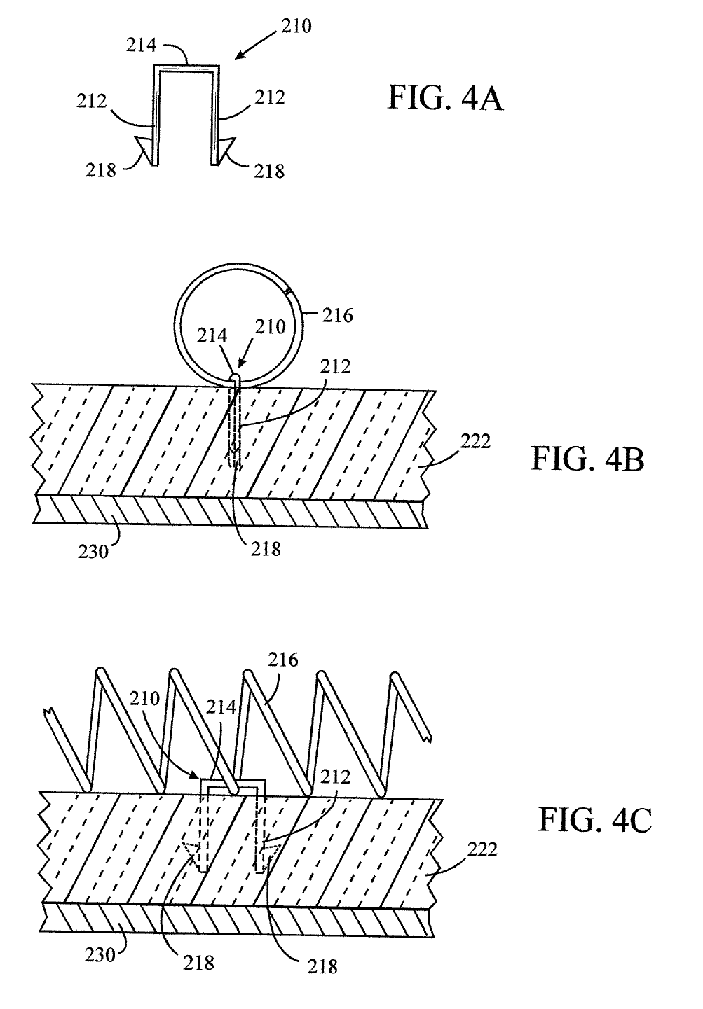

FIGS. 4A-4B illustrate another embodiment of a staple 210. In this embodiment, the heating unit has a coiled heating element 216, a first insulation layer 220, a support pan 230, and a plurality of staples 210. The first insulation layer 220 may comprise of a cake base 222 and circumferential sidewalls 224. The first insulation layer 220 rests in the support pan 230. The coiled heating element 216 is supported on the cake base 122. Similar to the layout in FIG. 1, the coiled heating element 216 may be laid out in a serpentine or sinuous pattern on the insulating cake base 222.

The coiled heating element 216 is held to the insulation cake base 222 by a plurality of staples 210. In this embodiment, each staple 210 has a base 214, legs 212 and barbs 218. The legs 212 of the staple 210 are shorter than the thickness of the insulation cake base 222. Unlike the conventional staples, however, the staple 210 in this embodiment of the present invention has barbs 218. In one embodiment, staple 210 is stamped from a sheet of thin metal. In another embodiment, the barbs 218 are flat and are attached to the legs 212 via welding or an adhesive. The barbs 218 and the legs 212 of the staple 210 are pressed into the insulation cake base 222. The base 214 of the staple straddles one turn of the coiled heating element 218. The barbs 218 prevent the staple 210 from coming loose during repeated temperature cycles of the heating element 216. As shown in FIGS. 4B-4C, the benefit of this embodiment is that the staple 210 (with barbs 218) does not require a second insulation layer.

What has been described is a staple for heating units usable both domestically, and in commercial food establishments, to retain a heating element during repeated temperature cycles. Although a coiled heating element is used to describe the above embodiments, it is contemplated that the present invention may be applicable to other types of heating elements such as ribbon-type heating elements where extra retention is necessary. In view of the foregoing, it will be seen that the several objects of the invention are achieved and other advantageous results are obtained.

As various changes could be made in the above constructions without departing from the scope of the invention, it is intended that all matter contained in the above description or shown in the accompanying drawings shall be interpreted as illustrative and not in a limiting sense.

What is claimed is:

1. A staple for a heating unit, the heating unit having a base, a first insulation layer, a second insulation layer, and a heating element, the first insulation layer having a top surface and a bottom surface, the heating element resting on the top surface of the first insulation layer, the staple comprising:
a base for straddling a portion of the heating element; and
a plurality of legs, at least one leg extending through the top and bottom surfaces of the first insulation layer, a portion of the at least one leg extending through the bottom surface of the first insulation layer capable of being rolled to form a foot, the second insulation layer located between the bottom surface of the first insulation layer and the base.

2. The staple of claim 1, wherein the staple is made of a metallic alloy material.

3. The staple of claim 1, wherein the staple has a diameter of less than 0.012 inch.

4. The staple of claim 1, wherein the heating element is a coiled heating element.

5. The staple of claim 1, wherein each of the plurality of legs have a portion that extends through the bottom surface of the first insulation layer, the portion extending through the bottom surface capable of being rolled to form a foot.

6. The staple of claim 1, wherein the heating unit is for heating a grill plate.

7. A heating unit comprising:
a pan having a generally flat base and a circumferential sidewall;
a first insulation layer having an insulation base and a circumferential sidewall;
a second insulation layer positioned between the insulation base of the first insulation layer and the flat base of the pan;
a heating element supported on the insulation base of the first insulation layer;
a plurality of staples to retain the heating element on the insulation base of the first insulation layer, the staples extending through the insulation base of the first insulation layer.

8. The heating unit of claim 7, wherein each staple is made of a metallic alloy material.

9. The heating unit of claim 7, wherein each staple has a diameter of less than 0.012 inch.

10. The heating unit of claim 7, wherein the heating element is a coiled heating element.

11. The heating unit of claim 7, wherein a portion of the staples that extend through the insulation base of the first insulation layer is capable of being rolled to form a foot.

12. The heating unit of claim 7, wherein the heating unit is for heating a grill plate.

13. A staple for a heating unit, the heating unit having an insulation layer and a heating element, the insulation layer having a top surface, the heating element resting on the top surface of the insulation layer, staple comprising:
a base capable of straddling a portion of the heating element;
a leg extending from the base; and
a barb attached to the leg;
wherein the barb and a portion of the leg are capable of extending through the top surface of the insulation layer, the staple capable of retaining the heating element on the top surface of the insulation layer during repeated temperature cycles of the heating element.

14. The staple of claim 13, wherein the staple is made of a metallic alloy material.

15. The staple of claim 13, wherein the heating element is a coiled heating element.

16. The staple of claim 13, wherein the heating unit is for heating a grill plate.

17. A heating unit comprising:
a pan having a generally flat base and a circumferential sidewall;
an insulation layer having an insulation base and a circumferential sidewall, the insulation layer resting at least partially inside the pan;
a heating element supported on the insulation base of the insulation layer;
a plurality of staples to retain the heating element on the insulation base of the insulation layer, each staple having a base, at least one leg and at least one barb, the at least one barb attached to the at least one leg, the at least one barb and a portion of the at least one leg extending into the insulation base of the insulation layer.

18. The heating unit of claim 17, wherein each staple is made of a metallic alloy material.

19. The heating unit of claim 17, wherein the heating element is a coiled heating element.

20. The heating unit of claim 17, wherein the heating unit is for heating a grill plate.
